(19) United States
(12) Patent Application Publication
(10) Pub. No.: US 2003/0002029 A1
(43) Pub. Date: Jan. 2, 2003

(54) Marked, difficult-to-counterfeit documents

(76) Inventors: Shlomo Dukler, Tel Aviv (IL); Avi Landman, Kiryat Halm (IL)

Correspondence Address: ALTERA LAW GROUP, LLC, 6500 CITY WEST PARKWAY, SUITE 100, MINNEAPOLIS, MN, 55344-7704, US

(21) Appl. No.: 10/027,074

(22) Filed: Dec. 21, 2001

Related U.S. Application Data
(63) Continuation of application No. PCT/IL00/00005, filed on Jan. 3, 2000.

(30) Foreign Application Priority Data
Jun. 21, 1999 (IL) 130585

(51) Int. Cl. G06K 9/74

(52) U.S. Cl. 356/71

(57) ABSTRACT

A method for creating marked, difficult-to-counterfeit documents, comprising labeling printed documents produced by solid toner apparatus, such as a laser printer or a copying machine. The toner comprises a material the presence of which can be detected using spectrophotometric techniques. The toner is marked with a single compound, emitting light in a known spectrum. Two or more compounds having different spectra are mixed, so as to produce a characteristic “code” or “signature” as the result of their excitation with light. The amount of marked toner present at a given point on the document is preser as a threshold value, below which a document is considered not authentic. The position of the marked toner on the document is specifically selected, and the authenticity of the document is determined by detecting the presence of the marked toner at a specific location on the document.

### FIELD OF THE INVENTION

The invention relates to the marking of documents for the purpose of authentication, and to means for revealing the presence of the marks in documents.

### BACKGROUND OF THE INVENTION

The problem of marking various objects with identifying marks or codes, which are invisible in normal light, has been addressed several times in the prior art. For instance, U.S. Pat. No. 3,507,655 describes and claims a process for producing marking invisible in natural light but visible in ultraviolet (hereinafter UV) light on a plastic substrate exhibiting fluorescent properties, but wherein a source of intense optical radiation is impinged on the substrate through a stencil bearing the desired marking pattern, the radiation causing a change in the fluorescence in the substrate in the irradiated area, so that the marking is invisible in ordinary light, but visible under UV illumination.

U.S. Pat. Nos. 5,225,900 and 5,301,044 disclose incorporating patterns into marking materials used to create images. Reproduction systems detect the patterns and use the resulting information to control reproduction.

U.S. Pat. No. 4,366,217 discloses making a motion picture film which has a plurality of digitally coded sound tracks which are colored and transparent to visible light and which fluoresce when exposed to UV light.

None of the prior art systems, however, are successfully applicable to normal printing or copying systems and apparatus and they all involve operations additional to printing or copying, causing increased manufacturing complication and costs.

It is therefore a purpose of this invention to produce secure, marked documents, particularly by means of standard copying or printing equipment. While reference will be made hereinafter only to the production of documents, for the sake of brevity, it should be understood that the invention is applicable to any substrate on which any graphic matter, including e.g. letters, numbers, signs and/or pictures of any kind, can be produced by printing or copying systems and apparatus.

It is another purpose of this invention to produce, by standard copying or printing methods, labeled documents having identifying markings that are not visible to the naked eye, but the presence of which can be detected using spectrophotometric techniques.

It is a further purpose of this invention to produce documents which cannot be reproduced by photographic, xerographic or any other copying methods, since any such reproduction is easily recognizable from the original document, and the authenticity of which can therefore be verified.

It is a still further purpose of this invention to provide toner compositions, more specifically solid toner compositions, which, when used in standard printing or copying systems and apparatus, will produce labeled documents that are identifiable and any copies of which are distinguishable from the original.

It is yet another purpose of this invention to provide coded marked toner compositions, which can be used to generate many different codes through the use of combination of markers.

It is a still further purpose of this invention to provide a process for making such toner compositions.

It is a still further purpose of this invention to provide means for recognizing the labeled documents and distinguishing them from copies thereof.

Other purposes and advantages of this invention will appear as the description proceeds.

### SUMMARY OF THE INVENTION

The present invention relates to a method for labeling printed documents produced by solid toner apparatus, such as a laser printer or a copying machine, with a material the presence of which can be detected using spectrophotometric techniques, and thus can be used to verify the authenticity of the document. The labeling is invisible to the naked eye and does not interfere with the contents of the printed document.

The process of verifying the authenticity of the document involves the excitation of the marked toner with light in the range of 150-800 nm, and the measurement of the light emitted from the excited marked toner by a spectrometer. The document inspected must emit light having a spectrum identical to that preset for the specific document. Thus, an emission of light with the wrong spectrum will not identify the document as being authentic.

According to a preferred embodiment of the invention the toner is marked with a single compound, emitting light in a known spectrum.

According to another preferred embodiment of the invention, two or more compounds are mixed, having different spectra, so as to produce a characteristic “signature” as the result of their excitation with light.

According to another preferred embodiment of the invention, the amount of marked toner present at a given point on the document is preset as a threshold value, below which a document is considered not authentic. Thus, according to this particular embodiment of the invention, the amount of marked toner employed is also a factor in the characteristic signature of an authentic document.

According to a preferred embodiment of the invention the position of the marked toner on the document is also specifically selected, and the authenticity of the document is determined by detecting the presence of the marked toner as a specific location on the document.

According to the invention any toner of any type and color can be marked and used in conjunction with the invention. In any case, the labeling dyes, added to the toner and used in the production of the original labeled document, will not be present in any reproduction of the document, such as e.g. photographic or xerographic, carried out with conventional toner compositions, or at least, toner compositions different from those used in the original document, and their presence, which is detectable in the labeled, original document, will not be detected in any such reproduction thereof.

Any material that satisfies the requirements of the invention, viz., that can be excited by light irradiation and, as a result, emits light in a detectable amount and with a recognizable wavelength, can be used for the purposes of the invention. Illustrative and non-limitative examples of suitable marker compounds include:

7-diethylamino-4-methyl coumarin;

7-dimethylamino-4-trifluoromethyl coumarin;

7-amino-4-methyl coumarin;

7-amino-4-trifluoromethylcoumarin;

N-(4-anilino-1-naphthyl)maleimide;

Rhodamine 123;

Rubrene;

N,N′-Bis substituted perylene 3,4,9,10 tetracarboxyl-diimides such as N,N′-Ditridecyl-3,4,9,10-peryleneteracarboxylic diimide, N,N′-Bis(2,5-di-tertbutylphenyl)-3,4,9,10-perylenetetracarboximide, and N,N′-Bis(2,6-dimethyphenyl)-3,4,9,10-perylenetetracorboxylic diimide;

tetramethylrhodamineisothianate;

2,5-bis[5-tert-butylbenzenzoxxyolyl(2)thiobenzene];

9,10-bis(phenyl-ethyl)antracene;

9(p-vinytphenl)-I 0-phenyl-antracene;

Eosin B and Eosin Y;

Trans-4-[4(Dibutylamino)styryl]-1-(3-Sulfopropyl)pyridinium hydroxide;

Nile Red;

Nile Blue; and

4-(dicyanomethylene)-2-methyl-6-(4-dimethylamino-styryl)-4H-pyran.

A particularly preferred compound is N,N′-Ditridecyl-3,4,9,10-perylenetetracarboxylic diimide. This compound is listed as CA # 95689-92-2. The use of this compound in the production of fluorescent markings for the authentication of documents, is also a part of the present invention.

N,N′-Ditridecyl-3,4,9,10-perylenetetracarboxylic diimide has a fluorescence which changes in the lamination process, to which documents are often subjected. In the lamination, herein refereed to, the document is juxtaposed with its printed face to a transparent sheet or film and joined to it by the application of pressure and heat, in the presence of an adhesive. In this process, the fluorescence of said compound is shifted from that of the crystallites of the solid compound to the fluorescence of the same compound in a solution. It was found that N,N′-Ditridecyl-3,4,9,10-perylenetetracarboxylic diimide in the laminated document has a fluorescence which is similar to that of the compound in solution as to fluorescent emission spectrum, viz. to the wavelength ranges of the emission peaks, and which has a greater intensity than is expected in the solid state.

The fluorescence spectrums of this compound in solution and in laminated documents is shifted towards lower wavelengths—viz. “blue-shifted”—with respect to the fluorescence spectrum of its crystallites. This compound has an intense absorption band in the range of 450-530 nm. This is advantageous, as more light sources are available for excitation at this wavelength range, they are less expensive and safer than UV light sources. Its melting point is over 300° C., whereby it does not melt during the laser printing and particular during the setting operation by the application of pressure and heat, during which the toners are softened.

Another advantage of this preferred compound is that its maximum fluorescence emission in its solid state, which is at 690 nm, is far away and cannot be interfered by paper emission which could result from UV excitation. Since even after the lamination a part of the labeling compound is left in its solid state, a peak at 690 nm is still detectable, and can be used, though weak. If no lamination is carried out, more of the compound will be left in its solid state and the 690 nm peak can be used to identify the presence of the compound, particularly in view of its distance from paper emission.

Accordingly, as said, the invention comprises N,N′-Ditridecyl-3,4,9,10-perylenetetracarboxylic diimide, as a fluorescent labeling compound.

The invention additionally comprises labeled toner composition comprising toner particles and N,N′-Ditridecyl-3,4,9,10-perylenetetracarboxylic diimide; documents, labeled with N,N′-Ditridecyl-3,4,9,10-perylenetetracarboxylic diimide, whether comprised or not comprised in laminates; and laminates comprising documents labeled with N,N′-Ditridecyl-3,4,9,10-perylenetetracarboxylic diimide. In said documents subjected to lamination, said labeling compound has a fluorescent emission band at lower wavelength than 690 nm, and consistent with said compound's being in solution. In said documents, if not subjected to lamination, the said compound has, in addition, a fluorescent emission band with a peak at 690 nm, consistent with its being in the solid state.

### DETAILED DESCRIPTION OF PREFERRED EMBODIMENTS

The labeling composition, comprising the labeling compound according to this invention, is prepared as described hereinbefore and as will be exemplified hereinafter.

Once a printed document has been prepared by means of the labeled toner according to the invention, and when the printed document is subjected to lamination particularly with overlying transparent plastic layers, which have the purpose of protecting documents and preventing additions or counterfeiting, the compound dissolves in the adhesive which is released in the lamination process. Solution of the labeling compound into the glue causes a shift of its fluorescence from the fluorescence of the crystallites to the fluorescence of the material in the solution, to shorter wavelengths. The fluorescence intensity is heightened, with respect to that in the solid state.

A preferred form of the process by which toner colors and labeling dyes may be associated into toner composition, particularly when N,N′-Ditridecyl-3,4,9,10-perylenetetracarboxylic diimide is the labeling compound or label, comprises the following steps:

a—introducing the labeling compound N,N′-Ditridecyl-3,4,9,10-perylenetetracarboxylic diimide into an organic solvent, e.g. ethyl alcohol, whereby to produce a first suspension/solution of said labeling compound in said organic solvent;

b—applying a strong signification for a time sufficient to produce a uniform suspension/solution of said labeling compound particles in said first solution, whereby a moderate heating, typically to about 40° C., is obtained;

c—adding distilled water to said first suspension/solution to an amount that does not cause the precipitation of the labeling compound, whereby to obtain a second suspension/solution of said labeling compound in a mixture of the organic solvent and water;

d—adding the toner particles to said second suspension/solution while stirring;

e—diluting with distilled water to a sufficient extent to cause a homogenous precipitation of said labeling compound onto said toner particles, whereby to produce labeled toner particles;

f—stirring the above for an additional few hours, during which generally some organic solvent evaporates, causing further precipitation of the labeling comupound;

g—filtering said labeled toner particles from the liquid phase of said suspension;

h—drying the filtrate under vacuum; and

i—milling and sieving the dried filtrate.

A preferred organic solvent is ethanol. When ethanol is used, the aforesaid second solution is solution of said labeling compound in a solution of ethanol in water, typically at an ethanol concentration of about 5% to 10% by volume.

While said preferred form of the process has been described by reference to N,N′-Ditridecyl-3,4,9,10-perylenetetracarboxylic diimide as the label, it should be understood that it is also applicable to other labels, generally comprised in this invention, with the appropriate adjustments, if required by the physical and chemical characteristics of the label, that will be easily effected by persons skilled in the art.

If the process conditions set forth hereinbefore are not respected, unwanted results will occur. For instance, the toner particles will be totally covered and will change their color and their electrostatic properties; or numerous dye crystallites will be formed, that are not bound to toner particles and will not be transferred to the print substrate during the electrostatic process of the printing.

When multiple application of different labeling dyes is desired, one carries out the aforesaid procedure twice or more, once with each labeling dye, or carry out the aforesaid process once by mixing with the water suspension of the toner colors a solution in organic solvent of the mixture of the desired labeling dyes.

However, other methods can be used for producing the toner composition containing the toner colors and the labeling dyes. This can be done, for instance, by mixing them in solid, finely particulate form.

The fluorescent compound or compounds used should, as has been said, preferably be colorless and, therefore they may be considered colorless toners. They should also be such as not substantially to alter the colors of the toner colors, although some alteration is tolerable and can be taken into account. Likewise, it is desirable that the colorless toner should not affect substantially the electrostatic and thermal properties of the toner colors, and therefore nor interfere with their deposition on the print receiver or their setting by fusing in such processes as laser printing and the like.

The presence of the marked toner can be detected by any suitable spectrophotometric apparatus. An example of such apparatus is the FLM Aminco Bowman Series-2 spectrometer (ex Spectronic Instruments, Inc.—USA).

The marked toner can be used to label different parts of a document. For instance, in a passport the bearer's photograph may be labeled, or the bearer's signature can be printed with marked toner, and various combinations of different marks ca be used, to verify the authenticity of the document.

The method of the invention presents several important advantages. For instance, it can be applied to all kinds of laser printers, such as fax machines, photocopy machines and laser printers. It is possible to mark the toner using different markers, so as to generate different “codes” or “signatures”. The detection of the marked toner is made by spectrophotometric apparatus, and therefore the determination of the authenticity of the document is objective, and not human dependent. The marking can be used during the printing of personalized documents, e.g., on the signature or photograph of the bearer. Additionally, secure documents can be post-produced, viz., if desired the entire document can be printed with regular ink, and can be labeled later on using, the marked toner.

### EXAMPLE 1

Solutions of the luminescent material were prepared in a concentration of 0.001% to 10% in an alcoholic solution, such as, EtOH, Iso-propyl alcohol, n-butyl-alcohol or ethyl acetate. The solution was added to distilled water. The toner was dispersed in an aqueous solution, H₂O-EtOH 1:1 or H₂O-iso propyl alcohol. The solution of the luminescent pigment of concentration 0.001% to 10% was added to the aqueous-alcoholic solution and was mixed vigorously for up to two-hours using a laboratory mixer from 200-800 RPM. After filtering the toner from the aqueous-alcoholic solution, the powder was dried to room temperature and was ready for use.

By this method there were prepared cyan, yellow, magenta, and black toner, but the method is not limited to these colors and can be implemented on any color type including pigmentless or colorless toners.

While embodiments of the invention have been described by way of illustration, it will be apparent that the invention may be carried out by persons skilled in the art with many modifications, variations and adaptations, without departing from its spirit or exceeding the scope of the claims.

1. A method for creating marked, difficult-to-counterfeit documents, comprising labeling printed documents produced by solid toner apparatus, such as a laser printer or a copying machine, said toner comprising a material he presence of which can be detected using spectrophotometric techniques.

2. A method according to claim 1, wherein the toner is marked with a single compound, emitting light in a known spectrum.

3. A method according to claim 1, wherein two or more compounds are mixed, having different spectra, so as to produce a characteristic “code” or “signature” as the result of their excitation with light.

4. A method according to any one of claims 1 to 3, wherein the amount of marked toner present at a given point on the document is preset as a threshold value, below which a document is considered not authentic.

5. A method according to any one of claims 1 to 4, wherein the position of the marked toner on the document is specifically selected, and the authenticity of the document is determined by detecting the presence of the marked toner at a specific location on the document.

6. A process for verifying the authenticity of a document generated by the method of any one of claims 1 to 5, comprising exposing the document to be verified to light in the range of 150-800 nm, thereby exciting the marked toner, and measuring the light emitted from the excited marked toner by a spectrometer.

7. A method according to claim 6, wherein a document is considered authentic if it emits light having a spectrum identical to that preset for the specific document.

8. A marked, difficult-to-counterfeit document comprising a labeled portion produced by a toner comprising a material the presence of which can be detected using spectrophotometric techniques.

9. A document according to claim 8, wherein the toner is marked with a single compound, emitting light in a known spectrum.

10. A document according to claim 8, wherein two or more compounds are mixed, having different spectra, so as to produce a characteristic “code” or “signature” as the result of their excitation with light.

11. A document according to any one of claims 8 to 10, wherein the amount of marked toner present at a given point on the document is preset as a threshold value, below which a document is considered not authentic.

12. A document according to any one of claims 8 to 11, wherein the position of the marked toner an the document is specifically selected, and the authenticity of the document is determined by detecting the presence of the marked toner at a specific location on the document.

13. A document according to any one of claims 8 to 12, which has been printed by a laser printer.

14. A document according to any one of claims 8 to 13, which is selected from among an ID document, a passport, a driving license, banknotes, stocks, bonds, security papers, and any other document requiring protection against counterfeiting.

15. A laminated product, comprising a document according to any one of claims 8 to 14.

16. As a labeling compound, N,N′-Ditridecyl-3,4,9,10-perylenetetracarboxylic diimide.

17. Labeled toner composition comprising toner particles and a fluorescent dye.

18. Labeled toner composition according to claim 17, comprising toner particles and N,N′-Ditridecyl-3,4,9,10-perylenetetracarboxylic diimide.

19. Fluorescent labeling compound according to claim 16, having an intense absorption band in the range of about 450-530 nm and having a fluorescent emission peak in the solid, crystalline state, centers on about 690 nm.

20. Documents, labeled with N,N′-Ditridecyl-3,4,9,10-perylenetetracarboxylic diimide.

21. Laminates, comprising documents according to claim 20.

22. Laminates according to claim 21, labeled with N,N′-Ditridecyl-3,4,9,10-perylenetetracarboxylic diimide, wherein said labeling compound has a fluorescent emission band at wavelength lower than 690 nm and consistent with said compound's being in solution.

23. Process for preparing a labeled toner composition according to claim 17 or 18, which comprises the steps of:
a—introducing the labeling compound into an organic solvent whereby to produce a first suspension/solution of said labeling compound in said organic solvent;
b—applying a strong sonification for a time sufficient to produce a uniform suspension/solution of said labeling compound particles in said first solution, whereby a moderate heating, typically to about 40° C., is obtained;
c—adding distilled water to said first suspension/solution to an amount that does not cause the precipitation of the labeling compound, whereby to obtain a second suspension/solution of said labeling compound in a mixture of the organic solvent and water;
d—adding the toner particles to said second suspension/solution while stirring;
e—diluting with distilled water to a sufficient extent to cause a homogenous precipitation of said labeling compound onto said toner particles, whereby to produce labeled toner particles;
f—stirring the above for an additional few hours, during which generally some organic solvent evaporates, causing further precipitation of the labeling compound;
g—filtering said labeled toner particles from the liquid phase of said suspension;
h—drying the filtrate under vacuum; and
i—milling and sieving the dried filtrate.

24. Process according to claim 23, wherein the solvent of the second solution is a solution of ethanol in water.

25. Process according to claim 24, wherein the solution has a concentration of ethanol of about 5% to 10% by volume.

26. Process for recognizing documents according to claim 20, which comprises irradiating the document with VIS-light having a wavelength bard of about 450-530 nm and identifing, in the resulting fluorescent emission spectrum of the document, the peak characteristic of N,N′-Ditridecyl-3,4,9,10-perylenetetracarboxylic diimide in the solid and solution states.

27. Process for recognizing laminates according to claim 21, which comprises irradiating the laminate with UV-light having a wavelength band of about 450-530 nm and identifying, in the resulting fluorescent emission spectrum of the laminate, the peaks characteristic of N,N′-Ditridecyl-3,4,9,10-perylenetetracarboxylic diimide in solution.

28. N,N′-Ditridecyl-3,4,9,10-perylenetetracarboxylic diimide for use as a document labeling compound.

29. Use of N,N′-Ditridecyl-3,4,9,10-perylenetetracarboxylic diimide for the production of labeled documents, substantially as described in the specification.

30. A difficult-to-counterfeit document, substantially as described and illustrated.
